(19) United States
(12) Patent Application Publication
(10) Pub. No.: US 2026/0111790 A1
(43) Pub. Date: Apr. 23, 2026

(54) MITIGATING DATA LOSS IN DATA ANONYMIZATION PROCESSES

(71) Applicant: Google LLC, Mountain View, CA (US)

(72) Inventors: Vincent Cohen-Addad, Grenoble (FR); Alessandro Epasto, New York, NY (US); Vahab Seyed Mirrokni, Short Hills, NJ (US); Peilin Zhong, Jersey City, NJ (US)

(21) Appl. No.: 18/920,643

(22) Filed: Oct. 18, 2024

(51) Int. Cl. G06N 20/00

(52) U.S. Cl. CPC G06N 20/00

(57) ABSTRACT

A system and method for mitigating data loss in data anonymization processes. The method includes receiving, by a processing device, a first data item associated with first metadata, determining whether the first data item satisfies a sensitivity criterion, responsive to determining the first data item satisfies the sensitivity criterion, identifying, among a plurality of reference data items, a second data item that is closest to the first data item, wherein the second data item is associated with second metadata, determining whether a first similarity score the second data item satisfies a similarity criterion, responsive to determining the first similarity score satisfies the similarity criterion, generating synthetic data comprising the second data item and the first metadata, and using the synthetic data in training data for training an AI model to identify one or more patterns in the training data.

### TECHNICAL FIELD

The present disclosure relates generally to data anonymization. In particular, aspects and implementations of the present disclosure relate to mitigating data loss in data anonymization processes.

### BACKGROUND

Personally identifiable information (PII) or other sensitive information should be removed from data before the data is processed in order to comply with various privacy regulations and best practices.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

An aspect of the disclosure provides a computer-implemented method including: receiving, by a processing device, a first data item associated with first metadata; determining whether the first data item satisfies a sensitivity criterion; responsive to determining the first data item satisfies the sensitivity criterion, identifying, among a plurality of reference data items, a second data item that is closest to the first data item, wherein the second data item is associated with second metadata; determining whether a first similarity score the second data item satisfies a similarity criterion; responsive to determining the first similarity score satisfies the similarity criterion, generating synthetic data comprising the second data item and the first metadata; and using the synthetic data in training data for training an artificial intelligence (AI) model to identify one or more patterns in the training data.

In some aspects, the method further comprises: responsive to determining the first data item does not satisfy the sensitivity criterion, using the first data item associated with the first metadata in the training data for training the AI model.

In some aspects, the method further comprises: responsive to determining the first similarity score does not satisfy the similarity criterion, discarding the first data item and the first metadata.

In some aspects, generating the synthetic data comprises: determining whether the first data item associated with the first metadata corresponds to at least a predefined number of distinct users; and responsive to determining the first data item corresponds to the two or more distinct users, using the first metadata to generate the synthetic data.

In some aspects, the first similarity score between the first data item and the second data item reflects a distance between a first vector representation of the first data item and a second vector representation of the second data item.

In some aspects, the first data item comprises at least one of first text data, first audio data, first image data, or first video data, and wherein the first metadata comprises at least one of second text data, second audio data, second image data or second video data.

In some aspects, the first data item comprises a user-originated search query.

An aspect of the disclosure provides a system comprising a memory and one or more processing devices operatively coupled to the memory, the one or more processing devices to perform one or more of the operations of the method described herein above.

An aspect of the disclosure provides a computer-readable non-transitory storage medium comprising executable instructions for a server that, when executed by one or more processing devices of the server, cause the one or more processing devices to perform one or more operations of the method described herein above.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 is an example system, according to some aspects of the disclosure.

FIG. 2 is a block diagram illustrating an example data flow from received data to processing data, which is processed at the data processing module, according to some aspects of the disclosure.

FIG. 3 is a block diagram that illustrates using a training engine to generate training outputs based on training inputs, according to some aspects of the disclosure.

FIG. 4 is a block diagram illustrating one example of how synthetic data can be generated, according to some aspects of the present disclosure.

FIG. 5 is a flow diagram of an example method for mitigating data loss in data anonymization processes, according to some aspects of the disclosure.

FIG. 6 is a flow diagram of an example method for generating anonymized training data to train an artificial intelligence (AI) model, according to some aspects of the disclosure.

FIG. 7 is a block diagram illustrating an example of a computer system, according to aspects of the disclosure.

### DETAILED DESCRIPTION

Aspects of the present disclosure relate to mitigating data loss in data anonymization processes. Data anonymization can be performed on a user-originated dataset (e.g., search queries issued by multiple users) in order to remove sensitive information from the dataset, thus allowing the resulting anonymized dataset to be used for data processing operations, such as training artificial intelligence (AI) models.

In an illustrative example, a dataset can include one or more of search query data, text data, speech data, audio data, image data, video data, or the like. A data item of the data set can be associated with one or more metadata items, collectively referred as metadata. As used herein, “metadata” can refer to data that provides information about other data (e.g., the data item), and/or data that is otherwise associated with the data item. For example, the metadata can include statistical information such as a click count associated with a data item, an access count or an access type associated with the data item, a date or timestamp data associated with the data item, or the like. In another example, metadata associated with a search query can include a list of search query responses, cached webpages corresponding to the query responses, and/or data files corresponding to search query responses.

As used herein, “sensitive information” includes various private or proprietary information which should not be made public (e.g., due to such preference of the party that has originated the information). In particular, sensitive information may include personally identifiable information (PII), financial data, medical data, trade or industry data, or the like. Sensitive information may also include any data that could be used to infer characteristics, behaviors, preferences, or the like of a person or organization. In some instances, sensitive information may be further defined industry best-practices or data privacy frameworks, or by local, state, federal, or foreign laws or regulations, such as the California Consumer Privacy Act (CCPA), or the General Data Protection Regulation (GDPR).

Data anonymization may involve removing or obscuring sensitive information from the dataset in order to preserve the privacy, security, or identity of a person or organization. Often the sensitive information in a dataset is contained in data items of the dataset, but not in the respective metadata associated with each data item. And for many datasets, the utility of the dataset may be based on the association between data items and respective metadata associated with each data item. Thus, prioritizing the retention of a data item paired to respective metadata often increases the utility of the dataset. For example, a dataset may be used to train an artificial intelligence (AI) model to perform user-search query completions, or to interpret a user-search query based on context. In another example, a dataset may be used to train an AI model to determine an association between input pairs of a textual description (e.g., a data item) of an image (e.g., metadata). It can be appreciated by those skilled in the art that these types of datasets (e.g., pairs of data items and associated metadata) can be used in statistical models, deep learning neural networks (DNNs), large language models (LLMs), machine learning (ML) models, input clustering models, or the like. It can be appreciated that any loss of data from a dataset (including a loss of sensitive information) can reduce the utility of the dataset in any of the above example use-cases for the dataset.

Some methods for anonymizing data include data masking, tokenization, generalization, differential privacy, or k-anonymity. Data masking can include altering or removing specific data elements from a dataset by replacing sensitive information with random values. Tokenization can include replacing sensitive information in a dataset with encrypted “tokens” that map to the sensitive information. Generalization can reduce the precision of data items in a dataset by replacing specific values with estimates or broader categories. For example, an exact age may be replaced with an age range. Differential privacy can anonymize a dataset by introducing controlled random noise into the dataset such that an individual data item cannot be singled out. A k-anonymity data anonymization method can discard data items from a dataset that do not meet a certain frequency threshold, k. For example, for a k=2 anonymity requirement, any data item that does not appear two or more times in a dataset is discarded.

These and other data anonymization methods can anonymize datasets, however often the resulting dataset may not satisfy data anonymization requirements, or may have a significantly reduced utility in comparison to the original dataset.

Aspects of the present disclosure address these and other challenges by mitigating data loss in data anonymization processes. A data anonymization module receives an input dataset, such as a dataset including user-issued search queries. The input dataset can include data items that are each paired with associated metadata. As used herein, the associated metadata can be any data that is grouped with or corresponds to the data item, such as timestamp data, text data, audio data, image data, video data, file data, database data, or the like. The data anonymization module can separate the data items in the input dataset into two categories (i) data items that do not include sensitive information (e.g., “non-sensitive data item”), and (ii) data items that includes sensitive information (e.g., “sensitive data item”). For example, the data anonymization module separate a dataset of user-originated search queries into a list of search queries that do not contain sensitive information (e.g., non-sensitive search queries), and list of search queries containing sensitive information (e.g., sensitive search queries). In some embodiments, the data anonymization module can separate the data items in an input dataset using one of the data anonymization processes described above. For example, data items in the dataset that do not satisfy a k-anonymization threshold (e.g., a frequency threshold) can be categorized as sensitive data items, and data items that do satisfy the k-anonymization threshold can be categorized as non-sensitive data items. For sensitive data items, the data anonymization module can identify a respective closest non-sensitive data item. The data anonymization module can determine whether the identified non-sensitive data item is similar enough to the sensitive data item, based on a similarity criterion. If the non-sensitive data item is similar enough to the sensitive data item, the data anonymization module can generate synthetic data by pairing the non-sensitive data item with the metadata associated with the sensitive data item. In this way, the metadata paired with the sensitive that would have been discarded can be represented in the dataset, while the sensitive data is still properly discarded for anonymization purposes. For example, if a sensitive search query is similar enough to a non-sensitive search query, the data anonymization module can pair the non-sensitive search query with metadata associated with the sensitive search query. This pairing retains the metadata associated with the sensitive search query in the dataset, while discarding the sensitive search query from the dataset. The data anonymization module can add the resulting pair (e.g., a synthetic search query) to the non-sensitive list of search queries. In an illustrative example where the data anonymization module separates the dataset using a k-anonymity sensitivity criterion, the search query, “green dinosores” may not satisfy the sensitivity criterion because it does not appear with sufficient frequency in the dataset to satisfy the frequency threshold (e.g., less than the “k” value). Thus, the search query “green dinosores” may be placed on a sensitive search query list. However, “green dinosores” is a misspelling of what may be a non-sensitive search query, “green dinosaurs.” Thus, in this illustrative example, the metadata associated with the search query “green dinosores” can be paired with the similar search query “green dinosaurs,” and the resulting synthetic pair can be added to the non-sensitive search query list.

Advantages using this method to mitigate data loss in the anonymization process include a preservation of sensitive information in compliance with individual or organization requests, or applicable laws or regulations, an increase in the data that can be processed, an increased ability to draw more specific conclusions or identify non-generalized patterns in a dataset, and a reduction in data anonymization processing operations.

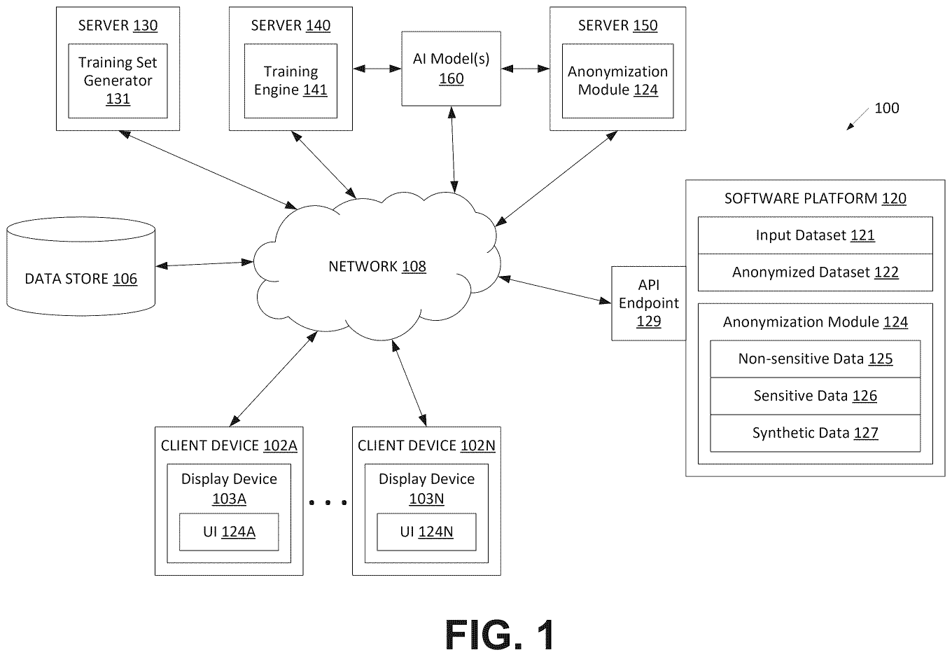

FIG. 1 illustrates an example of a system 100, according to some aspects of the disclosure. The system 100 includes client devices 102A-102N, a data store 106, a software platform 120, and a server 130, each connected to a network 108.

In implementations, network 108 can include a public network (e.g., the Internet), a private network (e.g., a local area network (LAN) or wide area network (WAN)), a wired network (e.g., Ethernet network), a wireless network (e.g., an 802.11 network or a wireless fidelity (Wi-Fi) network), a cellular network (e.g., a Long Term Evolution (LTE) network), routers, hubs, switches, server computers, and/or a combination thereof.

Data store 106 is a persistent storage that is capable of storing data as well as data structures to tag, organize, and index the data. In some implementations, data can include one or more of structured data, unstructured data, vectorized data, etc., or types of digital files, including text data, audio data, image data, video data, multimedia, interactive media, data objects, and/or any suitable type of digital resource, among other types of data. An example of data stored at the data store 106 can include a file, database record, database entry, programming code or document, among others. The data store 106 can be hosted by one or more storage devices, such as main memory, magnetic or optical storage based disks, tapes or hard drives, network-attached storage (NAS), storage area network (SAN), and so forth. In some implementations, the data store 106 can be a network-attached file server, while in other implementations the data store 106 can be another type of persistent storage such as an object-oriented database, a relational database, and so forth, that can be hosted by software platform 120, or one or more different machines coupled to the server hosting the software platform 120 via the network 108.

Software platform 120 can receive data (e.g., input dataset 121) from the client devices 102A-102N. The software platform 120 can use the anonymization module 124 to generate a portion of the anonymized dataset 122. The software platform 120 can provide the anonymized dataset 122 to the training set generator 131. The training set generator 131 can generate training data to train an artificial intelligence (AI) model, as described herein. In alternative embodiments, the software platform 120 can perform one or more operations on the anonymized dataset 122.

The input dataset 121 can include one or more of text data, audio data, image data, video data, file data, or the like. In some embodiments, the software platform 120 can collect the input dataset 121 from the client devices 102A-102N, or otherwise cause the client devices 102A-102N to send the data to the software platform 120. In some embodiments, the anonymized dataset 122 can include a portion of the input dataset 121 and an output from the anonymization module 124 (e.g., synthetic data 127).

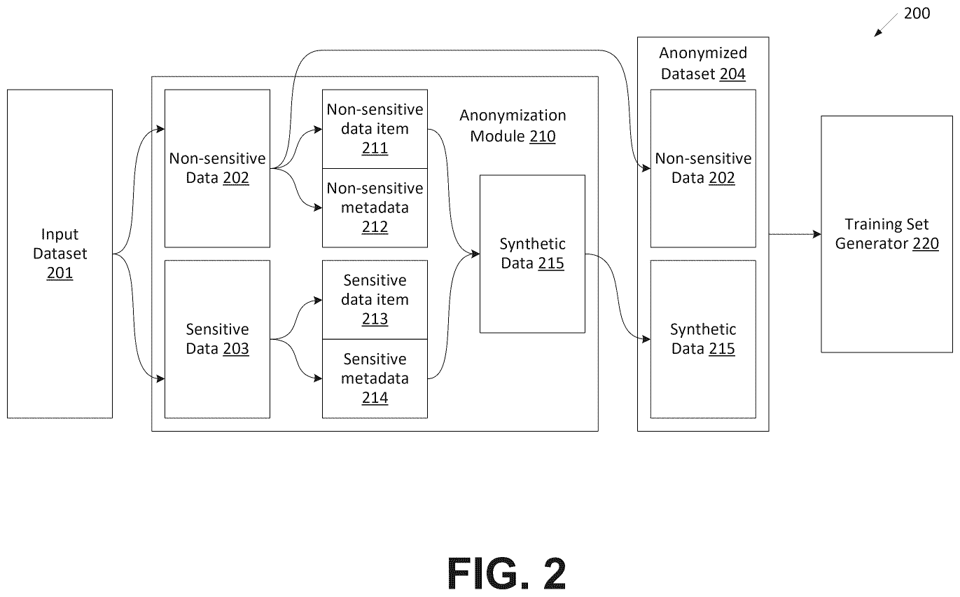

The anonymization module 124 can include non-sensitive data 125, sensitive data 126, and synthetic data 127. The anonymization module 124 can sort the input dataset 121 into non-sensitive and sensitive categories (e.g., non-sensitive data 125 and sensitive data 126). A data item is non-sensitive if it does not include sensitive information, and a data item is sensitive if it includes sensitive information. Using portions of the non-sensitive data 125 and portions of the sensitive data 126, The anonymization module 124 can generate synthetic data 127 based on a portion of non-sensitive data 125 (e.g., a non-sensitive data item) and a corresponding portion of sensitive data 126 (e.g., metadata corresponding to a sensitive data item). The synthetic data 127 can be added to the anonymized dataset 122 to represent a portion of the sensitive data 126 that otherwise would not be included in the anonymized dataset 122. The anonymized dataset can include a portion of the input dataset 121 (e.g., non-sensitive data 125). Additional details regarding generating the synthetic data 127 and the anonymized dataset 122 are described below with reference to FIG. 2.

The client devices 102A-102N can each include computing devices such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some implementations, client devices 102A-102N can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components. In some implementations, client devices 102A-102N can also be referred to as “user devices.” Each client device 102A-102N can include an audiovisual component that can generate audio and video data to be streamed to software platform 120. In some implementations, the audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user (e.g., a virtual meeting participant) associated with a particular client device. In some implementations, the audiovisual component can also include an image capture device (e.g., a camera) to capture images and generate video data (e.g., a video stream) of the captured data of the captured images.

In some implementations, the client devices 102A-102N can implement or include one or more applications to communicate (e.g., send and receive information) with the software platform 120. In some implementations, the client devices 102A-102N can implement a user interface (UI) (e.g., graphical user interfaces (GUIs)), such as a UI 124A-124N) that may be webpages rendered by a web browser and displayed on the client devices 102A-102N in a web browser window. In another embodiment, the UI 124A-124N of the client devices 102A-102N may be included in a stand-alone application downloaded to the client devices 102A-102N and natively running on the client devices 102A-102N (also referred to as a “native application” or “native client application” herein). In some implementations, some or all portions of the anonymization module 124 can be implemented at the client device 102A-102N.

Each client device 102A-102N can include a browser and/or a client application (e.g., a mobile application, a desktop application, etc.). In some implementations, the web browser and/or the client application can present, on a display device 103A-103N of client device 102A-102N, a user interface (UI) (e.g., a UI of the UIs 124A-124N) for users to access the software platform 120. For example, a user of client device 102A can join and participate in a virtual meeting via a UI 124A presented on the display device 103A by the web browser or client application. A user can also present a document to participants of the virtual meeting via each of the UIs 124A-124N. Each of the UIs 124A-124N can include multiple regions to present video streams corresponding to video streams of the client devices 102A-102N provided to the server 130 for the virtual meeting. In some implementations, the UIs 124A-124N may include various visual elements (e.g., UI elements) and regions, and can be a mechanism by which the user engages with the software platform 120, and system 100 at large. In some implementations, the UIs 124A-124N of the client devices 102A-102N can include multiple visual elements and regions that enable presentation of information, for decision-making, content delivery, etc. at the client devices 102A-102N. In some implementations, the UIs 124A-124N may sometimes be referred to as a graphical user interface (GUI)).

In some implementations, the UIs 124A-124N and/or client devices 102A-102N can include input features to intake information from a client devices 102A-102N. In one or more examples, a user of client devices 102A-102N can provide input data (e.g., a user query, control commands, etc.) into an input feature of the UIs 124A-124N or client devices 102A-102N, for transmission to the software platform 120, and system 100 at large. Input features of UIs 124A-124N and/or client devices 102A-102N can include space, regions, or elements of the UIs 124A-124N that accept user inputs. For example, input features may include visual elements (e.g., GUI elements) such as buttons, text-entry spaces, selection lists, drop-down lists, etc. For example, in some implementations, input features may include a chat box which a user of client devices 102A-102N can use to input textual data (e.g., a user query). The client devices 102A-102N can then transmit that textual data to software platform 120, and the system 100 at large, for further processing. In other examples, input features can include a selection list, in which a user of client devices 102A-102N can input selection data e.g., by selecting, or clicking. The client devices 102A-102N can then transmit that selection data to software platform 120, and the system 100 at large, for further processing.

In some implementations, the client device 102A-102N can access or otherwise interact with the software platform 120 through network 108 using one or more application programming interface (API) calls via platform API endpoint 129. In some implementations, software platform 120 can include multiple platform API endpoints 129 that can expose services, functionality, or information of the software platform 120 to one or more client devices 102A-102N. In some implementations, a platform API endpoint 129 can be one end of a communication channel, where the other end can be another system, such as a client device 102A associated with a participant or user account. In some implementations, the platform API endpoint 129 can include or be accessed using a resource locator, such a universal resource identifier (URI), universal resource locator (URL), of a server or service. The platform API endpoint 129 can receive requests from other systems, and in some cases, return a response with information responsive to the request. In some implementations, HTTP (Hypertext Transfer Protocol), HTTPS (Hypertext Transfer Protocol Secure) methods (e.g., API calls) can be used to communicate to and from the platform API endpoint 129.

In some implementations, the platform API endpoint 129 can function as a computer interface through which access requests are received and/or created. In some implementations, the platform API endpoint 129 can include a platform API whereby external entities or systems can request access to services and/or information provided by the software platform 120. The platform API can be used to programmatically obtain services and/or information associated with a request for services and/or information.

In some implementations, the API of the platform API endpoint 129 can be any suitable type of API such as a REST (Representational State Transfer) API, a GraphQL API, a SOAP (Simple Object Access Protocol) API, and/or any suitable type of API. In some implementations, the software platform 120 can expose through the API, a set of API resources which when addressed can be used for requesting different actions, inspecting state or data, and/or otherwise interacting with the software platform 120. In some implementations, a REST API and/or another type of API can work according to an application layer request and response model. An application layer request and response model can use HTTP, HTTPS, SPDY, or any suitable application layer protocol. Herein HTTP-based protocol is described for purposes of illustration, rather than limitation. The disclosure should not be interpreted as being limited to the HTTP protocol. HTTP requests (or any suitable request communication) to the software platform 120 can observe the principals of a RESTful design or the protocol of the type of API. RESTful is understood in this document to describe a Representational State Transfer architecture. The RESTful HTTP requests can be stateless, thus each message communicated contains all necessary information for processing the request and generating a response. The platform API can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

It can be appreciated that in some implementations, any element, such as server 130, and/or data store 106 may include a corresponding API endpoint for communicating with APIs.

In some implementations, software platform 120 and/or server 130 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to enable a user to connect with other users via a virtual meeting. Software platform 120 can also include a website (e.g., a webpage) or application back-end software that may be used to enable a user to connect with the software platform 120.

The system can include a AI model 160. In some implementations, the AI model 160 is an artificial intelligence (AI) model (e.g., also referred to as an “machine learning (ML) model” herein). An AI model can include a discriminative machine learning model (also referred to as “discriminative AI model” herein), a generative machine learning model (also referred to as “generative AI model” herein), and/or other AI model(s).

In some implementations, a discriminative AI model can model a conditional probability of an output for given input(s). A discriminative AI model can learn the boundaries between different classes of data to make predictions on new data. In some implementations, a discriminative AI model can include a classification model that is designed for classification tasks, such as learning decision boundaries between different classes of data and classifying input data into a particular classification. Examples of discriminative AI models include, but are not limited to, support vector machines (SVM) and neural networks.

In some implementations, a generative AI model learns how the input training data is generated and can generate new data (e.g., original data). A generative AI model can model the probability distribution (e.g., joint probability distribution) of a dataset and generate new samples that often resemble the training data. Generative AI models can be used for tasks involving image generation, text generation and/or data syn-thesis. Generative AI models include, but are not limited to, gaussian mixture models (GMMs), variational autoencoders (VAEs), generative adversarial networks (GANs), large language models (LLMs), vision-language models (VLMs), multi-modal models (e.g., text, images, video, audio, depth, physiological signals, etc.), and so forth.

Server 130 includes a training set generator 131 that is capable of generating training data (e.g., a set of training inputs and a set of target outputs) to train the AI model 160 (e.g., a generative machine learning model). In some implementations, training set generator 131 can generate the training data based on various data (e.g., stored at data store 106 or another data store connected to system 100 via the network 108). The data store 106 can store metadata associated with the training data.

Server 140 includes a training engine 141 that is capable of training a AI model 160 using the training data from training set generator 131. The AI model 160 (also referred to “machine learning model” or “artificial intelligence (AI) model” herein) may refer to the model artifact that is created by the training engine 141 using the training data that includes training inputs (e.g., features) and corresponding target outputs (correct answers for respective training inputs) (e.g., labels). The training engine 141 may find patterns in the training data that map the training input to the target output (the answer to be predicted) and provide the AI model 160 that captures these patterns. The AI model 160 may be composed of, e.g., a single level of linear or non-linear operations (e.g., a support vector machine (SVM), or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like. AI model 160 can use one or more of a support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), a boosted decision forest, etc. For convenience rather than limitation, the remainder of this disclosure describing a discriminative machine learning model will refer to the implementation as a neural network, even though some implementations might employ other types of learning machine instead of, or in addition to, a neural network.

In some implementations, such as with a supervised machine learning model, the one or more training inputs of the set of the training inputs are paired with respective one or more training outputs of the set of training outputs. The training input-output pair(s) can be used as input to the machine learning model to help train the machine learning model to determine, for example, patterns in the data.

In some implementations, the AI model 160 can be a generative AI model. A generative AI model is an AI model which can generate new, original data. A AI model 160 can include a generative adversarial network (GAN) and/or a variational autoencoder (VAE). In some instances, a GAN, a VAE, and/or other types of generative AI models can employ different approaches to training and/or learning the underlying probability distributions of training data, compared to some AI models.

For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

In some implementations, the AI model 160 can be a generative large language model (LLM). In some implementations, the AI model 160 can be a large language model that has been pre-trained on a large corpus of data so as to process, analyze, and generate human-like text based on given input.

In some implementations, the AI model 160 may have any architecture for LLMs, including one or more architectures as seen in Generative Pre-trained Transformer (GPT) series (Chat GPT series LLMs), Google's Gemini®, or LaMDA, or leverage a combination of transformer architecture with pre-trained data to create coherent and contextually relevant text.

In some implementations, a AI model 160, such as an LLM, can use an encoder-decoder architecture including one or more self-attention mechanisms, and one or more feed-forward mechanisms. In some implementations, the AI model 160 can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A AI model 160 can also utilize the previously discussed deep learning techniques, including recurrent neural networks (RNNs), convolutional neural networks (CNNs), or transformer networks.

In some implementations, the AI model 160 can be a multi-modal generative AI model, such as a Visual-Language Model (VLM). In some implementations, the AI model 160 can be a VLM that has been pre-trained on a large corpus of data (e.g., textual data and image data) so as to process, analyze, and generate human-like text and/or image data based on given input (e.g., image data and/or natural language text).

In some implementations, training a generative AI model can include providing training input to a AI model 160, and the AI model 160 can produce one or more training outputs. The one or more training inputs can be compared to one or more evaluation metrics. An evaluation metric can refer to a measure used to assess the output (e.g., training output(s)) of a AI model, such as a AI model 160. In some implementations, the evaluation metric can be specific to the task and/or goals of the AI model. Based on the comparison, one or more parameters and/or weights of the AI model 160 can be adjusted (e.g., backpropagation based on computed loss). In some implementations, and for example, the one or more training outputs can be compared to an evaluation metric such as a ground truth (e.g., target output, such as a correct or better answer). In some implementations and for example, the one or more training outputs can be evaluated/compared to an evaluation metric and can be rewarded (e.g., evaluated as a positive answer) or penalized (e.g., evaluated as a negative answer) based on the quality of the one or more training outputs (e.g., reinforcement learning).

In some implementations, a validation engine (not shown) may be capable of validating a AI model 160 using a corresponding set of features of a validation set from the training set generator. In some implementations, the validation engine may determine an accuracy of each of the trained generative models, such as AI model 160 (e.g., accuracy of the training output) based on the corresponding sets of features of the validation set. The validation engine may discard a trained AI model 160 that has an accuracy that does not meet a threshold accuracy. In some implementations, a selection engine not shown) may be capable of selecting a AI model 160 that has an accuracy that meets a threshold accuracy. In some implementations, the selection engine may be capable of selecting the trained AI model 160 that has the highest accuracy of the trained generative models (e.g., AI model 160).

A testing engine (not shown) may be capable of testing a trained AI model 160 using a corresponding set of features of a testing set from the training engine 141. For example, a first trained AI model 160 that was trained using a first set of features of the training set may be tested using the first set of features of the testing set. The testing engine may determine a trained AI model 160 that has the highest accuracy of all of the trained AI models based on the testing sets.

In some implementations, a AI model 160 can be trained on a corpus of data, such textual data and/or image data. In some implementations, the AI model 160 can be a model that is first pre-trained on a corpus of text to create a foundational model (e.g., also referred to as “pre-trained model” herein), and afterwards adapted (e.g., fine-tuned or transfer learning) on more data pertaining to a particular set of tasks to create a more task-specific or targeted generative AI model (e.g., also referred as an “adapted model” herein.) The foundational model can first be pre-trained using a corpus of data (e.g., text and/or images) that can include text and/or image content in the public domain, licensed content, and/or proprietary content (e.g., proprietary organizational data). The AI model 160 can use pre-training to learn broad image elements and/or broad language elements including general sentence structure, common phrases, vocabulary, natural language structure, and any other elements commonly associated with natural language in a large corpus of text. In example, the pre-trained model can be fine-tuned to the specific task or domain that the AI model 160 is to be adapted. In some implementations, AI model 160 may include one or more pre-trained models or adapted models.

In some implementations, training data, such as training input and/or training output, and/or input data to a trained machine learning model (collectively referred to as “machine learning model data” herein) can be preprocessed before providing the aforementioned data to the (trained or untrained) machine learning model (e.g., discriminative machine learning model and/or generative machine learning model) for execution. Preprocessing as applied to machine learning models (e.g., discriminative machine learning model and/or generative machine learning model) can refer to the preparation and/or transformation of machine learning model data.

In some implementations, preprocessing can include data scaling. Data scaling can include a process of transforming numerical features in raw machine learning model data such that the preprocessed machine learning model data has a similar scale or range. For example, Min-Max scaling (Normalization) and/or Z-score normalization (Standardization) can be used to scale the raw machine learning model. For instance, if the raw machine learning model data includes a feature representing temperatures in Fahrenheit, the raw machine learning model data can be scaled to a range of [0, 1] using Min-Max scaling.

In some implementations, preprocessing can include data encoding. Encoding data can include a process of converting categorical or text data into a numerical format on which a machine learning model can efficiently execute. Categorical data (e.g., qualitative data) can refer to a type of data that represents categories and can be used to group items or observations into distinct, non-numeric classes or levels. Categorical data can describe qualities or characteristics that can be divided into distinct categories, but often does not have a natural numerical meaning. For example, colors such as red, green, and blue can be considered categorical data (e.g., nominal categorical data with no inherent ranking). In another example, “small,” “medium,” and “large” can be considered categorical data (ordinal categorical data with an inherent ranking or order). An example of encoding can include encoding a size feature with categories [“small,” “medium,” “large”] by assigning 0 to “small,” 1 to “medium,” and 2 to “large.”

In some implementations, preprocessing can include data embedding. Data embedding can include an operation of representing original data in a different space, often of reduced dimensionality (e.g., dimensionality reduction), while preserving relevant information and patterns of the original data (e.g., lower-dimensional representation of higher-dimensional data). The data embedding operation can transform the original data so that the embedding data retains relevant characteristics of the original data and is more amenable for analysis and processing by machine learning models. In some implementations embedding data can represent original data (e.g., word, phrase, document, or entity) as a vector in vector space, such as continuous vector space. Each element (e.g., dimension) of the vector can correspond to a feature or property of the original data (e.g., object). In some implementations, the size of the embedding vector (e.g., embedding dimension) can be adjusted during model training. In some implementations, the embedding dimension can be fixed to help facilitate analysis and processing of data by machine learning models.

In some implementations, the training set is obtained from server 130. Server 150 includes a anonymization module 124 that provides current data (e.g., log information, etc.) as input to the trained machine learning model (e.g., AI model 160) and runs the trained machine learning model (e.g., AI model 160) on the input to obtain one or more outputs.

In some implementations, confidence data can include or indicate a level of confidence of that a particular output (e.g., output(s)) corresponds to one or more inputs of the machine learning model (e.g., trained machine learning model). In one example, the level of confidence is a real number between 0 and 1 inclusive, where 0 indicates no confidence that output(s) corresponds to a particular one or more inputs and 1 indicates absolute confidence that the output(s) corresponds to a particular one or more inputs. In some implementations, confidence data can be associated with inference using a machine learning model.

In some implementations, a machine learning model, such as AI model 160, may be (or may correspond to) one or more computer programs executed by processor(s) of server 140 and/or server 150. In other implementations, a machine learning model may be (or may correspond to) one or more computer programs executed across a number or combination of servers. For example, in some implementations, machine learning models may be hosted on the cloud, while in other implementations, these machine learning models may be hosted and perform operations using the hardware of a client devices 102A-102N. In some implementations, the machine learning models may be a self-hosted machine learning model, while in other implementations, machine learning models may be external machine learning models accessed by an API.

It is appreciated that in some other implementations, the functions of server 130 or software platform 120 can be provided by a fewer number of machines. For example, in some implementations, server 130 can be integrated into a single machine, while in other implementations, server 130 can be integrated into multiple machines. In addition, in some implementations, server 130 can be integrated into software platform 120.

In general, functions described in implementations as being performed by software platform 120 or server 130 can also be performed by the client devices 102A-102N in other implementations, if appropriate. In addition, the functionality attributed to a particular component can be performed by different or multiple components operating together. Software platform 120 and/or server 130 may also be accessed as a service provided to other systems or devices through appropriate application programming interfaces, and thus is not limited to use in websites.

Although implementations of the disclosure are discussed in terms of software platform 120 and users of software platform 120 participating in a virtual meeting, implementations can also be generally applied to any type of telephone call or conference call between users. Implementations of the disclosure are not limited to virtual meeting platforms that provide virtual meeting tools to users.

In implementations of the disclosure, a “user” or “participant” can be represented as a single individual. However, other implementations of the disclosure encompass a “user” or “participant” being an entity controlled by a set of users and/or an automated source. For example, a set of individual users federated as a community in a social network may be considered a “user” or “participant.” In another example, an automated consumer can be an automated ingestion pipeline, such as a topic channel, of the software platform 120.

In situations in which the systems discussed here collect personal information about users, or may make use of personal information, the users can be provided with an opportunity to control whether software platform 120 collects user information (e.g., information about a user's social network, social actions or activities, profession, a user's preferences, or a user's current location), or to control whether and/or how to receive content from the server 130 that can be more relevant to the user. In addition, certain data can be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the software platform 120 and/or server 130.

FIG. 2 is a block diagram illustrating an example flow 200 from input dataset 201 to anonymized dataset 204, which is processed at the training set generator 220, according to some aspects of the disclosure.

The anonymization module 210 separates the input dataset 201 into non-sensitive data 202 and sensitive data 203 using a sensitivity criterion. The sensitivity criterion can be based on anonymization requirements for datasets that include sensitive information. In some embodiments, the sensitivity criterion is determined based on industry best practices, data privacy standards, or by local, state, federal, or foreign laws or regulations, such as the CCPA or GDPR. In some embodiments, the sensitivity criterion is based on a k-anonymity data privacy requirement. The k-anonymity data privacy requirement can be a frequency criterion for data items in the dataset. That is, if the data item occurs more frequently in the input dataset 201 than the frequency criterion (e.g., the k-value), the anonymization module 210 can categorize the data item as non-sensitive data 202. Alternatively, if the data item occurs less frequently in the input dataset 201 than the frequency criterion (e.g., the sensitivity criterion for a k-anonymity data privacy requirement), the anonymization module 210 can categorize the data item as sensitive data 203.

In some embodiments, the anonymization module 210 can categorize the input dataset 201 using a sensitivity criterion based on a differential privacy requirement, where noise is added to the dataset in a controlled manner. A differential privacy requirement can be represented by the privacy parameter ε. As the value of ε approaches 0, a single data item becomes less identifiable from other data items in a dataset. That is, the measurable effect of a single input data item on an output generated by processing the dataset also approaches 0. Thus, as ε gets larger, a single data item becomes more identifiable from other data items in a dataset. That is, the measurable effect of the single data item input on an output generated by processing the dataset increases. The condition for ε in differential privacy is:

$$P ( M ( D ) = 0 ) \leq {e}^{ε} \times ( P ( M ( {D}^{′} ) = 0 )$$

where M is a mechanism that adds noise to the dataset D, M(D) is the output of the mechanism M on the dataset D, M(D′) is the output of the mechanism M on the dataset D′ which is a dataset that differs from the dataset D by one data item, O is any possible outcome of the mechanism, P denotes the probability of a certain outcome, and ε is a positive real number that bounds how much the probability of any outcome O can change when a single data item is added or removed from the dataset D. In alternative embodiments, the anonymization module 210 can categorize the input dataset 201 using a sensitivity criterion based on any other numerically quantifiable indication of sensitive information similar to the k-anonymity frequency criterion or the privacy parameter ¿, as described above.

The anonymization module 210 can further separate the non-sensitive data 202 and the sensitive data 203 into respective data items and associated metadata, illustrated here as non-sensitive data items 211 associated with non-sensitive metadata 212 and sensitive data items 213 associated with sensitive metadata 214. In some embodiments, the anonymization module 210 separates the data items from the metadata based on predefined data item or metadata item definitions. For example, a predefined data item definition can be “user-originated search query,” such data a user provides in an input field of an internet search indexing engine, and a corresponding metadata definition can be “data related to the search query,” such as search result data including any text data, audio data, image data, video data, file data, database data, or the like that may be included or referenced in a response to the search query. In alternative embodiments, the data item definition and metadata definition can be determined by the anonymization module 210. The anonymization module 210 can identify the sensitive information in the sensitive data 203 and separate the sensitive information from other associated data in the sensitive data 203. The separated sensitive information can be the sensitive data item 213, and the remaining data associated with the sensitive information can be the sensitive metadata 214. The anonymization module 210 can determine the type, structure, or one or more characteristics of the sensitive data item 213, and can use the determined type, structure, or characteristics to separate the sensitive data 202 into non-sensitive data items 211 and non-sensitive metadata 212. For example, if the sensitive data 203 includes image data paired with text data describing the image data, where the text data includes sensitive information, the text data can be categorized as a sensitive data item 213, and the image data can be categorized as sensitive metadata 214. The non-sensitive data 202 of the dataset of image data paired to with text data describing the image data can be similarly separated into text data (e.g., a non-sensitive data item 211) and image data (e.g., the non-sensitive metadata 212). In another example, the sensitive data 203 and non-sensitive data 202 can each include timestamp data and text data that correspond to sensitive image data. The sensitive image data can be categorized as sensitive data items 213 (or non-sensitive data item 211, respectively) and the corresponding timestamp and text data can be categorized as sensitive metadata 214 (or non-sensitive metadata 212, respectively).

The anonymization module 210 can determine, for each sensitive data item 213, a closest reference data item, such as a non-sensitive data item 211. In some embodiments, closest means the closest data item semantically. In some embodiments, “closest” can be measured numerically. That is, each sensitive data item 213 and each non-sensitive data item 211 can be converted into numerical representations. A closest non-sensitive data item to a particular sensitive data item can be a smallest difference between the numerical representation of the non-sensitive data item 213 and the sensitive data item 211. For example, the numerical representations for the sensitive data item 211 and the non-sensitive data item 213 can be vector representations. A closest non-sensitive data item to a particular sensitive data item can be a shortest distance between two respective vector representations. In some embodiments, the anonymization module 210 can use rank embedding, such as bidirectional encoder representations from transformers (BERT) to generate numerical values for each non-sensitive data item 211 and each sensitive data item 213. The rank embeddings that are generated for each data item reflect semantic meanings of the respective data item. Thus, the difference between two vectors that are generated using rank embeddings can represent a difference between the semantics of the respective data items. That is, a smaller difference between the two vectors indicates a greater similarity in semantics between the two data items, and a larger difference between the two vectors indicates a greater dissimilarity in semantics between the two data items. In embodiments where the data items are non-text data, the data items can be converted to text data and then vectors can be generated using rank embedding. In alternative embodiments where the data items are non-text data, analogous comparison methods and metrics may be used to determine a closest non-sensitive data item for each sensitive data item. In some embodiments, the anonymization module 210 can use an approximate nearest neighbor (ANN) algorithm to identify a closest non-sensitive data item for a particular sensitive data item.

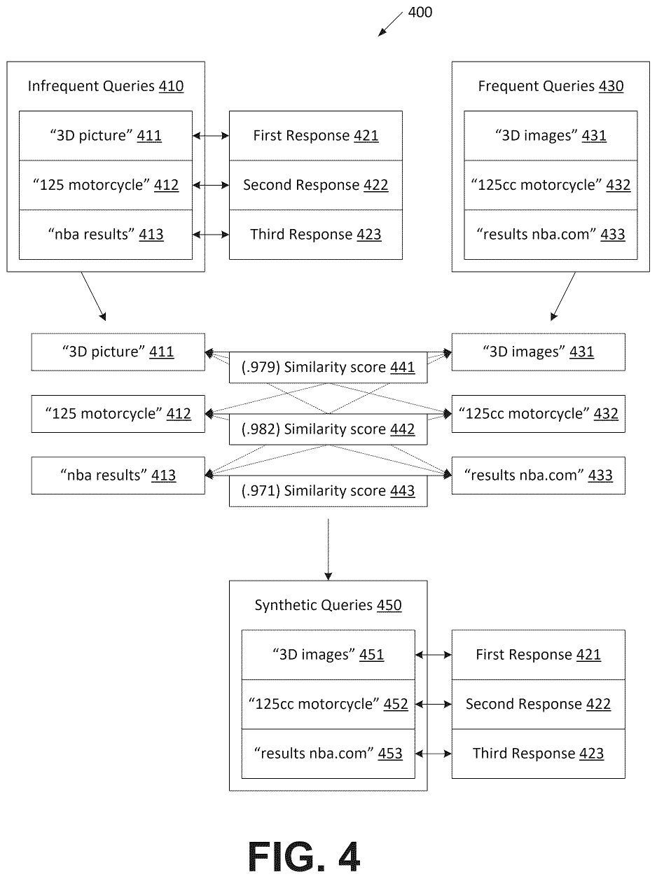

The anonymization module 210 can determine whether the closest non-sensitive data item for a particular sensitive data item satisfies a similarity criterion. The similarity criterion can be based on a maximum dissimilarity between the closest non-sensitive data item and the particular sensitive data item. In some embodiments, the similarity criterion is a predefined value or distance. In some embodiments, the similarity criterion can be based on the input dataset 201. For example, the similarity criterion for an input dataset 201 that includes text data can be based on the differences between a misspelled word and a correctly spelled word. In another example, the similarity criterion for an input dataset 201 that includes image data can be based on a difference in a number of image pixels of a certain color value, or a difference in location(s) of image pixels of certain color values between two images, or the like. Additional details regarding determining a similarity between an non-sensitive data item 211 and a sensitive data item 213 are described below with reference to FIG. 4.

Once a non-sensitive data item 211 has been identified as corresponding to the sensitive data item 213 (e.g., by satisfying the similarity criterion), the non-sensitive data item 211 can be paired with the sensitive metadata 214 as synthetic data 215. The synthetic data 215 can be used with the non-sensitive data 202 in the anonymized dataset 204. In some implementations, the anonymized dataset 204 can be used as a training dataset for training an AI model. That is, the anonymized dataset 204 can be provided to the training set generator 220, similar to or the same as the training set generator 131 of FIG. 1 to train the AI model 160.

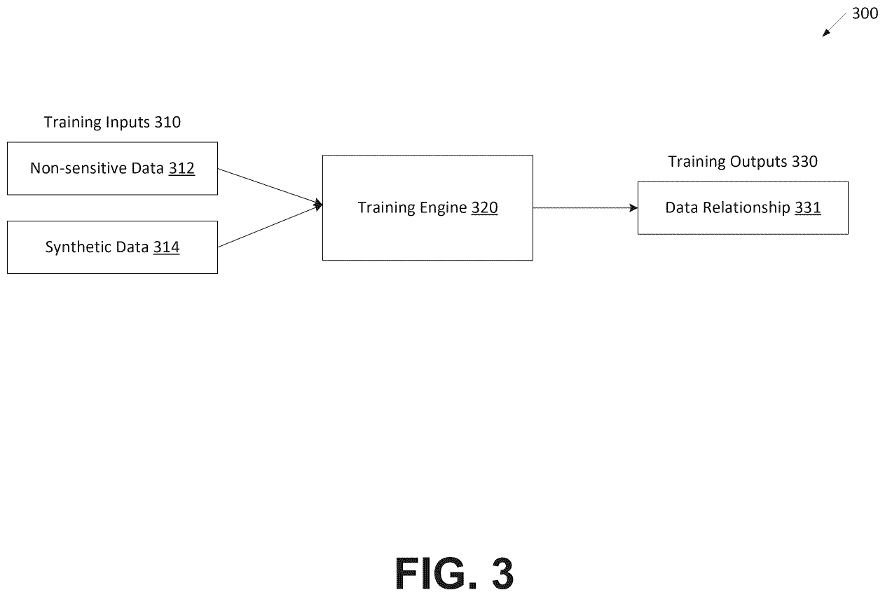

FIG. 3 is a block diagram 300 that illustrates using a training engine 320 to generate training outputs 330 based on training inputs 310, according to some aspects of the disclosure. In some implementations, the training engine 320 is the same as or similar to the training engine 141 described in FIG. 1. In some implementations, the training engine 320 is used to train a supervised AI model. In some implementations, the training engine 320 is used to train an unsupervised AI model. In some implementations, the training engine 320 is used to train a discriminative AI model. In some implementations, the training engine 320 is used to train a generative AI model.

The training inputs 310 include non-sensitive data 312 and synthetic data 314. The non-sensitive data 312 is data from a received dataset that satisfy one or more privacy threshold criterions, or the like. The synthetic data 314 is data generated by an anonymization module, such as the anonymization module 124 described with reference to FIG. 1 or the anonymization module 210 described with reference to FIG. 2. The synthetic data 314 is generated data that also satisfies the one or more privacy threshold criterions. In some embodiments, portions of the synthetic data 314 can be the same as or similar to portions of the non-sensitive data 312. In some embodiments, prior to providing the training inputs 310 to the training engine 320, a sensitive information test can be performed on the combined dataset of the non-sensitive data 312 and the synthetic data 314 (e.g., processing data) to verify that the combined dataset satisfies the one or more privacy threshold criterions. If the combined dataset does not satisfy the one or more privacy threshold criterions, the combined dataset can be anonymized to generate new non-sensitive data and new synthetic data, such as is described with reference to FIG. 2, where the input dataset 201 would include the non-sensitive data 312 and the synthetic data 314 instead of the non-sensitive data 202 and sensitive data 203 as illustrated.

The training engine 320 can train a model to receive the non-sensitive data 312 and the synthetic data 314 and generate a data relationship 331 as an output. The data relationship 331 can indicate any relationship between data items of the non-sensitive data 312 and/or data items of the synthetic data 314. In some embodiments, the data relationships 331 can indicate one or more clusters of data items contained in the non-sensitive data 312 and the synthetic data 314. In an alternative embodiment, the data relationships 331 can indicate one or more trends of data items in the non-sensitive data 312 and the synthetic data 314.

In some implementations, the training engine 320 can further train a base model (e.g., a pretrained model) using the non-sensitive data 312 and synthetic data 314. The further training of the base model can enable the retrained model to more accurately characterized a particular data relationship, such as the data relationship 331. In some embodiments, the training engine 320 can be used as a training set generator, such as the training set generator 131 to generate target outputs from a set of target inputs.

FIG. 4 is a block diagram 400 illustrating one example of how synthetic data can be generated, according to some aspects of the present disclosure. The block diagram includes infrequent queries 410, frequent queries 430, and synthetic queries 450, with connecting logic in between each of the query types. It can be appreciated that any data, whether textual or numeric, is merely illustrative and not necessarily indicative of real world data.

Infrequent queries 410 includes examples of search queries that are provided by users to an internet search indexing engine. As labeled, the first infrequent query 411 is “3D picture,” the second infrequent query 412 is “125 motorcycle,” and the third infrequent query 413 is “nba results.” In data anonymization processes, such as a k-anonymity anonymization process, these infrequent queries 410 could be categorized as sensitive data if they do not satisfy the privacy criterion for the data anonymization process, as described above. Each infrequent query 410 is paired with a respective infrequent response, such as first response 421, second response 422, or third response 423. These responses can be generated in response to the user-submitted search query and can include text data, audio data, image data, video data, indexing data, file data, or the like.

Frequent queries 430 also includes examples of search queries that are provided by users to an internet search indexing engine. As labeled, the first frequent query 431 is “3D images,” the second frequent query 432 is “125 cc motorcycle,” and the third frequent query 433 is “results nba.com.” In data anonymization processes, such as the k-anonymity anonymization process, these frequent queries 430 could be categorized as non-sensitive data if they satisfy the privacy criterion for the data anonymization process, as described above. Similar to the infrequent queries 410, each frequent query 430 can be paired to a respective response. However, this is not illustrated as the paired response (e.g., metadata of the non-sensitive data) is not used to generate the synthetic query (e.g., synthetic data as described above).

An anonymization module, such as anonymization module 124 of FIG. 1 or anonymization module 210 of FIG. 2 can generate a similarity score between each of the infrequent queries 410 (e.g., sensitive data) and the frequent queries 430 (e.g., non-sensitive data). The highest similarity scores are illustrated here in solid lines, with representative values, where “1” would be a complete similarity and “0” would be a complete dissimilarity. As illustrated the first similarity score 441 is between the first infrequent query 411 and the first frequent query 431, the second similarity score 442 is between the second infrequent query 412 and the second frequent query 432, and the third similarity score 443 is between the third infrequent query 413 and the third frequent query 433. Given a similarity threshold criterion of 0.97, each of the infrequent queries 410 can be represented or replaced by the frequent queries 430, based on the respective illustrative similarity scores when the anonymization module generates the synthetic queries 450. Thus, in the illustrative example the first infrequent query 411, “3D picture,” is replaced with the first frequent query 431, “3D images,” for the first synthetic query 451. Similarly, the second infrequent query 412, “125 motorcycle,” is replaced with the second frequent query 432, “125 cc motorcycle” for the second synthetic query 452. Similarly, the third infrequent query 413, “nba results,” is replaced with the third frequent query 433, “results nba.com” for the third synthetic query 453.

To finish generating the synthetic queries 450, the anonymization module pairs the respective responses of the infrequent queries to the corresponding synthetic queries, as illustrated. Thus, the first synthetic query 451 is paired with the first response 421, the second synthetic query 452 is paired with the second response 422, and the third synthetic query 453 is paired with the third response 423.

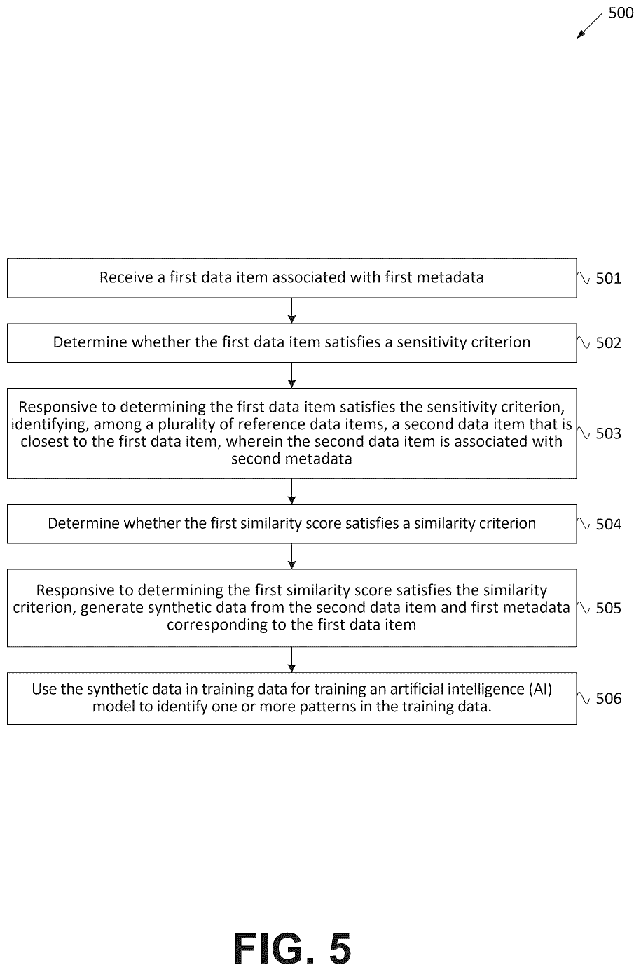

FIG. 5 is a flow diagram of an example method 500 for mitigating data loss in data anonymization processes, according to some aspects of the disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every embodiment. Other process flows are possible.

At operation 501, the processing logic performing the method 500 receives a first data item associated with first metadata. In some embodiments, data items (e.g., the first data item or the second data item) include one or more of text data, audio data, image data, video data, or the like. In some embodiments, metadata associated with the data items (e.g., the first metadata or the second metadata) include one or more of text data, audio data, image data, video data, or the like.

At operation 502, the processing logic determines whether the first data item satisfies a sensitivity criterion. The sensitivity criterion can be based on a numerical privacy value, such as is determined using the k-anonymity or differential privacy technique described herein above.

At operation 503, responsive to determining the first data item satisfies the sensitivity criterion, the processing logic identifies, among a plurality of reference data items, a second data item that is closest to the first data item, wherein the second data item is associated with second metadata. The closest second data item can be determined as a shortest distance between a vector representation of the first data item and a vector representation of the second data item. In some embodiments, the processing logic determines a similarity score between a first data item and a second data item associated with second metadata. In some embodiments, the first data item does not satisfy the sensitivity criterion, and can be categorized as a sensitive data item. In some embodiments, the second data item satisfies the sensitivity criterion, and can be categorized as an non-sensitive data item. In some embodiments, responsive to determining the first data item does not satisfy the sensitivity criterion, the first data item and first metadata associated with the first data item are used in training data for training the AI model. That is, the first data item can be categorized as an non-sensitive data item.

At operation 504, the processing logic determines whether the similarity score satisfies a threshold criterion. In some embodiments, the similarity score is determined based on vector representations of each of the first data item and the second data item. That is, a first vector representation can be generated for the first data item and a second vector representation can be generated for the second data item. The processing logic can determine the first similarity score as a distance (or difference) between the first vector representation and the second vector representation. In some embodiments, the first similarity score reflects the distance between the first vector representation and the second representation. In some embodiments, the processing logic can determine whether the similarity score between the first data item and the second data item is larger than a similarity score between the first data item and a third data item. As used herein, larger similarity scores indicate a higher similarity (e.g., a better match) between data items. That is, the processing logic can determine whether the similarity score is a largest similarity score for a set of calculated similarity scores. In some embodiments, the processing logic can determine a largest possible similarity score for each data item in a dataset. In some embodiments, the similarity score can be determined using an ANN algorithm. In some embodiments, the ANN algorithm identifies the data item (e.g., the second data item) in the dataset with the lowest similarity score to the first data item

At operation 505, responsive to determining the similarity score satisfies the threshold criterion, the processing logic generates synthetic data from the second data item and first metadata corresponding to the first data item. In some embodiments, responsive to determining the first similarity score does not satisfy the similarity criterion, the processing logic refrains from generating the synthetic data. In some embodiments, the processing logic can determine whether the first data item corresponds to two or more distinct users. In an alternative embodiment, the processing logic can determine whether the first data item satisfies a user count criterion, wherein the user count criterion is based on a number of distinct users.

At operation 506, the processing logic can use the synthetic data in training data to train an AI model to identify one or more patterns in the training data.

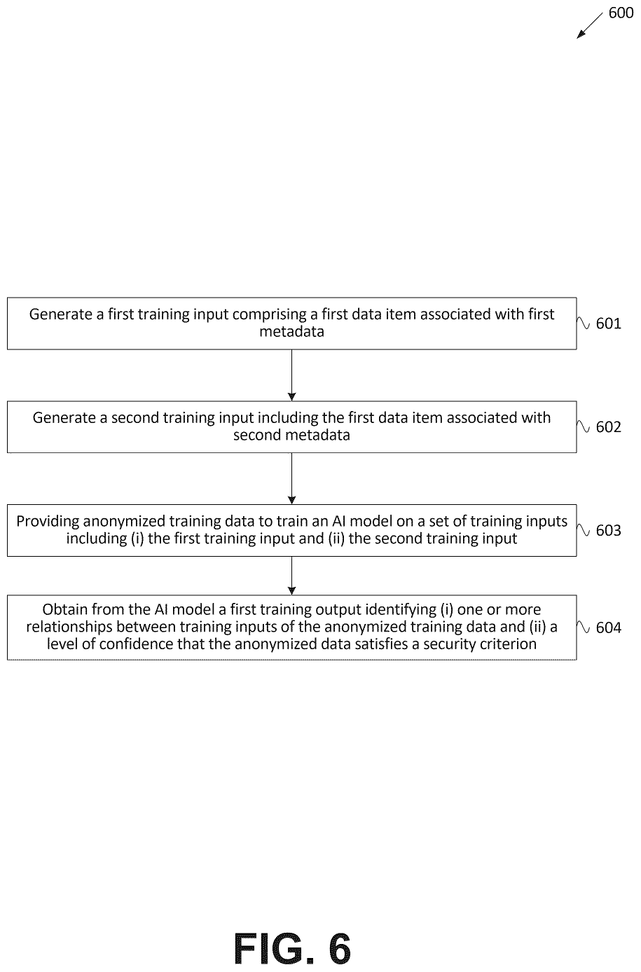

FIG. 6 is a flow diagram of an example method 600 for generating anonymized training data to train an artificial intelligence (AI) model, according to some aspects of the disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every embodiment. Other process flows are possible.

At operation 601, the processing logic performing the method 600 generates a first training input comprising a first data item and first metadata. The first data item is associated with first metadata.

At operation 602, the processing logic generates a second training input including the first data item and second metadata. The first data item is associated with the second metadata. In some embodiments, generating the second training input includes determining a similarity score between the first data item and a second data item associated with the second metadata. The processing logic can determine whether the similarity score satisfies a threshold criterion. Responsive to determining the similarity score satisfies the threshold criterion, the processing logic can associate the second metadata with the first data item to generate the second training input. That is, the processing logic can generate synthetic data (e.g., the second data item) using the first data item and the second metadata associated with the second data item. In some embodiments, the processing logic can determine whether the generated synthetic data satisfies a sensitive information threshold criterion. That is, the processing logic can determine whether the synthetic data can be categorized as non-sensitive data, as described above.

In some embodiments, the similarity score between the first data item and the second data item is determined based on vector representations of each of the first data item and the second data item. That is, a first vector representation can be generated for the first data item and a second vector representation can be generated for the second data item. The processing logic can determine the first similarity score as a distance (or difference) between the first vector representation and the second vector representation. In some embodiments, the processing logic can determine whether the similarity score between the first data item and the second data item is lower than a similarity score between the first data item and a third data item. That is, the processing logic can determine whether the similarity score is a lowest similarity score for a set of calculated similarity scores. In some embodiments, the processing logic can determine a lowest possible similarity score for each data item in a dataset. In some embodiments, the similarity score can be determined using an ANN algorithm.

At operation 603, the processing logic provides anonymized training data to train an AI model on a set of training inputs including (i) the first training input and (ii) the second training input.

At operation 604, the processing logic obtains from the AI model a first training output identifying (i) one or more relationships between training inputs of the anonymized training data and (ii) a level of confidence that the anonymized training data satisfies a security criterion.

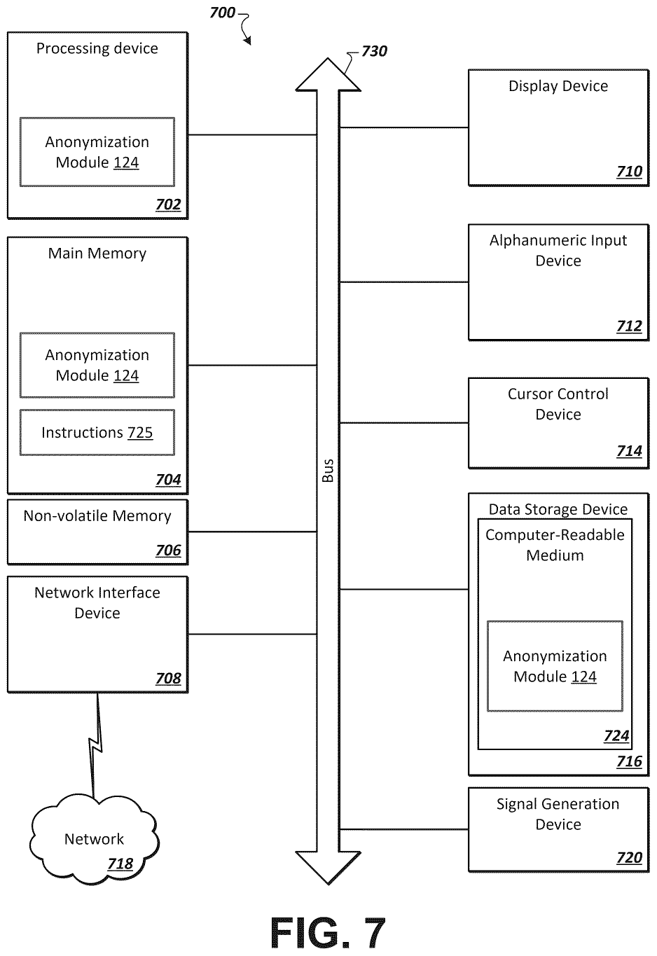

FIG. 7 is a block diagram illustrating an example of a computer system 700, according to aspects of the disclosure. The computer system 700 can correspond to software platform 120 and/or client devices 102A-102N, described in FIG. 1. Computer system 700 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 700 includes a processing device 702 (e.g., a processor), a main memory 704 (e.g., read-only memory (ROM), flash memory, dynamic random access memory (DRAM) such as synchronous DRAM (SDRAM), double data rate (DDR) SDRAM, or DRAM (RDRAM), etc.), a non-volatile memory 706 (e.g., flash memory, static random access memory (SRAM), etc.), and a data storage device 716, which communicate with each other via a bus 730. In some embodiments, the main memory 704 can be a non-transitory computer readable storage medium.

Processing device 702 represents one or more general-purpose processing devices such as a microprocessor, central processing unit, or the like. More specifically, processing device 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 can also be one or more special-purpose processing devices such as an application specific integrated circuit (ASIC), a field programmable gate array (FPGA), a digital signal processor (DSP), network processor, or the like. The processing device 702 is configured to execute network interface device 708 (e.g., for synchronizing data between platforms) for performing the operations discussed herein. The processing device 702 can be configured to execute instructions 725 stored in main memory 704. Non-volatile memory 706 can store the instructions 725 when they are not being executed, and can store additional system data that can be accessed by processing device 702. The processing device 702 can be operatively coupled to the main memory 704 and/or the non-volatile memory 706.

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 718 (e.g., a speaker).

The data storage device 716 can include a computer-readable storage medium 724 (e.g., a computer-readable non-transitory storage medium) on which is stored one or more sets of executable instructions, such as instructions 725 (e.g., for performing the data anonymization process) embodying any one or more of the methodologies or functions described herein. The instructions can also reside, completely or at least partially, within the main memory 704 and/or within the processing device 702 during execution thereof by the computer system 700, the main memory 704 and the processing device 702 also constituting machine-readable storage media. The instructions can further be transmitted or received over a network 720 via the network interface device 708.

While the computer-readable storage medium 724 (non-transitory computer-readable storage medium) is illustrated in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a specific feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the specific features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specific by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
receiving, by a processing device, a first data item associated with first metadata;
determining whether the first data item satisfies a sensitivity criterion;
responsive to determining the first data item satisfies the sensitivity criterion, identifying, among a plurality of reference data items, a second data item that is closest to the first data item, wherein the second data item is associated with second metadata;
determining whether a first similarity score the second data item satisfies a similarity criterion;
responsive to determining the first similarity score satisfies the similarity criterion, generating synthetic data comprising the second data item and the first metadata; and
using the synthetic data in training data for training an artificial intelligence (AI) model to identify one or more patterns in the training data.

2. The method of claim 1, comprising:
responsive to determining the first data item does not satisfy the sensitivity criterion, using the first data item associated with the first metadata in the training data for training the AI model.

3. The method of claim 1, comprising:
responsive to determining the first similarity score does not satisfy the similarity criterion, discarding the first data item and the first metadata.

4. The method of claim 1, wherein generating the synthetic data further comprises:
determining whether the first data item associated with the first metadata corresponds to at least a predefined number of distinct users; and
responsive to determining the first data item corresponds to at least the predefined number of distinct users, using the first metadata to generate the synthetic data.

5. The method of claim 1, wherein the first similarity score between the first data item and the second data item reflects a distance between a first vector representation of the first data item and a second vector representation of the second data item.

6. The method of claim 1, wherein the first data item comprises at least one of first text data, first audio data, first image data, or first video data, and wherein the first metadata comprises at least one of second text data, second audio data, second image data or second video data.

7. The method of claim 1, wherein the first data item comprises a user-originated search query.

8. A system comprising:
a memory; and
one or more processing devices operatively coupled to the memory, the one or more processing devices to:
receive a first data item associated with first metadata;
determine whether the first data item satisfies a sensitivity criterion;
responsive to determining the first data item satisfies the sensitivity criterion, identifying, among a plurality of reference data items, a second data item that is closest to the first data item, wherein the second data item is associated with second metadata;
determine whether a first similarity score the second data item satisfies a similarity criterion;
responsive to determining the first similarity score satisfies the similarity criterion, generate synthetic data comprising the second data item and the first metadata; and
use the synthetic data in training data for training an artificial intelligence (AI) model to identify one or more patterns in the training data.

9. The system of claim 8, wherein the one or more processing devices further to:
responsive to determining the first data item does not satisfy the sensitivity criterion, use the first data item associated with the first metadata in the training data for training the AI model.

10. The system of claim 8, wherein the one or more processing devices further to:
responsive to determining the first similarity score does not satisfy the similarity criterion, discard the first data item and the first metadata.

11. The system of claim 8, wherein generating the synthetic data, the one or more processing devices further to:
determine whether the first data item associated with the first metadata corresponds to at least a predefined number of distinct users; and
responsive to determining the first data item corresponds to the predefined number of distinct users, use the first metadata to generate the synthetic data.

12. The system of claim 8, wherein the first similarity score between the first data item and the second data item reflects a distance between a first vector representation of the first data item and a second vector representation of the second data item.

13. The system of claim 8, wherein the first data item comprises at least one of first text data, first audio data, first image data, or first video data, and wherein the first metadata comprises at least one of second text data, second audio data, second image data or second video data.

14. The system of claim 8, wherein the first data item comprises a user-originated search query.

15. A computer-readable non-transitory storage medium comprising executable instructions for a server that, when executed by one or more processing devices of the server cause the one or more processing devices to:
receive a first data item associated with first metadata;
determine whether the first data item satisfies a sensitivity criterion;
responsive to determining the first data item satisfies the sensitivity criterion, identifying, among a plurality of reference data items, a second data item that is closest to the first data item, wherein the second data item is associated with second metadata;
determine whether a first similarity score the second data item satisfies a similarity criterion;
responsive to determining the first similarity score satisfies the similarity criterion, generate synthetic data comprising the second data item and the first metadata; and
use the synthetic data in training data for training an artificial intelligence (AI) model to identify one or more patterns in the training data.

16. The computer-readable non-transitory storage medium of claim 15, wherein the one or more processing devices further to:
responsive to determining the first data item does not satisfy the sensitivity criterion, use the first data item associated with the first metadata in the training data for training the AI model.

17. The computer-readable non-transitory storage medium of claim 15, wherein the one or more processing devices further to:
responsive to determining the first similarity score does not satisfy the similarity criterion, discard the first data item and the first metadata.

18. The computer-readable non-transitory storage medium of claim 15, wherein generating the synthetic data, the one or more processing devices further to:
determine whether the first data item associated with the first metadata corresponds to at least a predefined number of distinct users; and
responsive to determining the first data item corresponds to the predefined number of distinct users, use the first metadata to generate the synthetic data.

19. The computer-readable non-transitory storage medium of claim 15, wherein the first similarity score between the first data item and the second data item reflects a distance between a first vector representation of the first data item and a second vector representation of the second data item.

20. The computer-readable non-transitory storage medium of claim 15, wherein the first data item comprises at least one of first text data, first audio data, first image data, or first video data, and wherein the first metadata comprises at least one of second text data, second audio data, second image data or second video data.
